(19) United States
(12) Patent Application Publication
(10) Pub. No.: US 2016/0192224 A1
(43) Pub. Date: Jun. 30, 2016

(54) APPARATUS, SYSTEM AND METHOD OF PREDICTING A CHANNEL CONDITION

(71) Applicant: INTEL CORPORATION, Santa Clara, CA (US)

(72) Inventors: Michael Faerber, Wolfratshausen,BY (DE); Apostolos Papathanassiou, San Jose, CA (US)

(21) Appl. No.: 14/582,814

(22) Filed: Dec. 24, 2014

(51) Int. Cl. H04W 24/10; H04W 4/02; H04B 7/02; H04W 8/08; H04L 5/00; H04W 48/18; H04W 48/04; H04W 28/02

(52) U.S. Cl. CPC H04W 24/10; H04W 48/04; H04W 4/02; H04W 28/021; H04W 8/08; H04L 5/0048; H04W 48/18; H04B 7/024

(57) ABSTRACT

Some demonstrative embodiments include apparatuses, devices, systems and methods of predicting a channel condition. For example, A User Equipment (UE) may include a radio to communicate over a millimeter Wave (mmWave) band with at least one network (NW) element of a network controlled by a cellular node, and to receive from the NW element topology information corresponding to a topology at a location of the UE; and a channel estimator to predict a channel condition of a channel between the UE and the cellular node based on the topology information.

### TECHNICAL FIELD

Embodiments described herein generally relate to predicting a channel condition.

### BACKGROUND

A User Equipment (UE) may communicate with a Base Station (BS) over a channel between the UE and the BS.

The UE may predict a channel condition of the channel between the UE and the BS, for example, to maintain quality and/or to improve performance of the communication between the UE and the BS.

In an inter-site Coordinated Multi-Point (CoMP) solution, base stations may work in cooperation to acquire downlink Channel State Information (CSI) data, for example, to enable Multiple-In-Multiple-Out (MIMO) joint pre-coding communication.

The CSI data may be determined inaccurately, for example, due to implementation impairments. The inaccurate CSI data may be used by all transceivers of the CoMP. As a result, the inaccurate CSI data may reduce performance of the MIMO communication.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic illustration of a network controlled by a cellular node, in accordance with some demonstrative embodiments.

FIG. 3 is a schematic flow chart illustration of a method of predicting a channel condition, in accordance with some demonstrative embodiments.

FIG. 4 is a schematic illustration of a product of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, one way and/or two-way radio communication systems, cellular radio-telephone communication systems, a node, a base station, a server computer, a wireless communication station, a wireless communication device, a wireless Access Point (AP), a wired or wireless router, a wired or wireless modem, a wired or wireless network, a wireless area network, a cellular network, a cellular node, a Wireless Local Area Network (WLAN), a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, multi-standard radio devices or systems, and the like.

Some embodiments may be used in conjunction with devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11ac-2013 (“IEEE P802.11ac-2013, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 Dec., 2012); IEEE 802.11REVmc, IEEE 802.11x) and/or future versions and/or derivatives thereof, devices and/or networks operating in accordance with existing Long Term Evolution (LTE) specifications (including ETSI TS 136 300 V11.3.0 (2012-11): LTE; Evolved Universal Terrestrial Radio Access (E-UTRA) and Evolved Universal Terrestrial Radio Access Network (E-UTRAN); Overall description; Stage 2 (3GPP TS 36.300 version 11.3.0 Release 11), 2012) and/or future versions and/or derivatives thereof, units and/or devices which are part of the above networks, and the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), second generation (2G), 2.5G, 3G, 3.5G, 4G, Fifth Generation (5G) mobile networks, 3GPP, Long Term Evolution (LTE) cellular system, LTE advance cellular system, High-Speed Downlink Packet Access (HSDPA), High-Speed Uplink Packet Access (HSUPA), High-Speed Packet Access (HSPA), HSPA+, Single Carrier Radio Transmission Technology (1×RTT), Evolution-Data Optimized (EV-DO), Enhanced Data rates for GSM Evolution (EDGE), and the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some demonstrative embodiments are described herein with respect to a LTE cellular network. However, other embodiments may be implemented in any other suitable cellular network, e.g., a 3G cellular network, a 4G cellular network, a 5G cellular network, a WiMax cellular network, and the like.

Some demonstrative embodiments may be used in conjunction with a WLAN. Other embodiments may be used in conjunction with any other suitable wireless communication network, for example, a wireless area network, a “piconet”, a WPAN, a WVAN and the like.

Some demonstrative embodiments may be used in conjunction with a wireless communication network communicating over a frequency band of 60 GHz. However, other embodiments may be implemented utilizing any other suitable wireless communication frequency bands, for example, an Extremely High Frequency (EHF) band (the millimeter wave (mmWave) frequency band), e.g., a frequency band within the frequency band of between 20 Ghz and 300 GHZ, a WLAN frequency band, a WPAN frequency band, a Wireless-Gigabit (WiGig) frequency band, e.g., according to the WGA specification, a WiFi frequency band, a Wi-Fi Direct frequency band, a frequency band according to the IEEE 802.11 standards, e.g., according to IEEE 802.11 ad (“the 802.11 ad frequency band”), a frequency band according to the Wi-Fi standards, and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

The phrase “mmWave frequency band” as used herein may relate to a frequency band above 20 GHz, e.g., a frequency band between 20 GHz and 300 GHz.

Some demonstrative embodiments are described herein with respect to mmWave radio resources and/or mmWave wireless communication links, however other embodiments may be used in conjunction with any other suitable radio resources and/or any other wireless communication links.

The phrases “directional multi-gigabit (DMG)” and “directional band” (DBand), as used herein, may relate to a frequency band wherein the Channel starting frequency is above 40 GHz.

The phrases “DMG STA” and “mmWave STA (mSTA)” may relate to a STA having a radio transmitter, which is operating on a channel that is within the mmWave or DMG band.

The term “cell”, as used herein, may include a combination of network resources, for example, downlink and optionally uplink resources. The resources may be controlled and/or allocated, for example, by a wireless communication node (also referred to as a “node” or a “base station”), or the like. The linking between a carrier frequency of the downlink resources and a carrier frequency of the uplink resources may be indicated in system information transmitted on the downlink resources.

Some demonstrative embodiments may be used in conjunction with a Heterogeneous Network (HetNet), which may utilize a deployment of a mix of technologies, frequencies, cell sizes and/or network architectures, e.g., including cellular, mmWave, and/or the like. In one example, the HetNet may include a radio access network having layers of different-sized cells ranging from large macro cells to small cells, for example, picocells and femtocells.

Other embodiments may be used in conjunction with any other suitable wireless communication network.

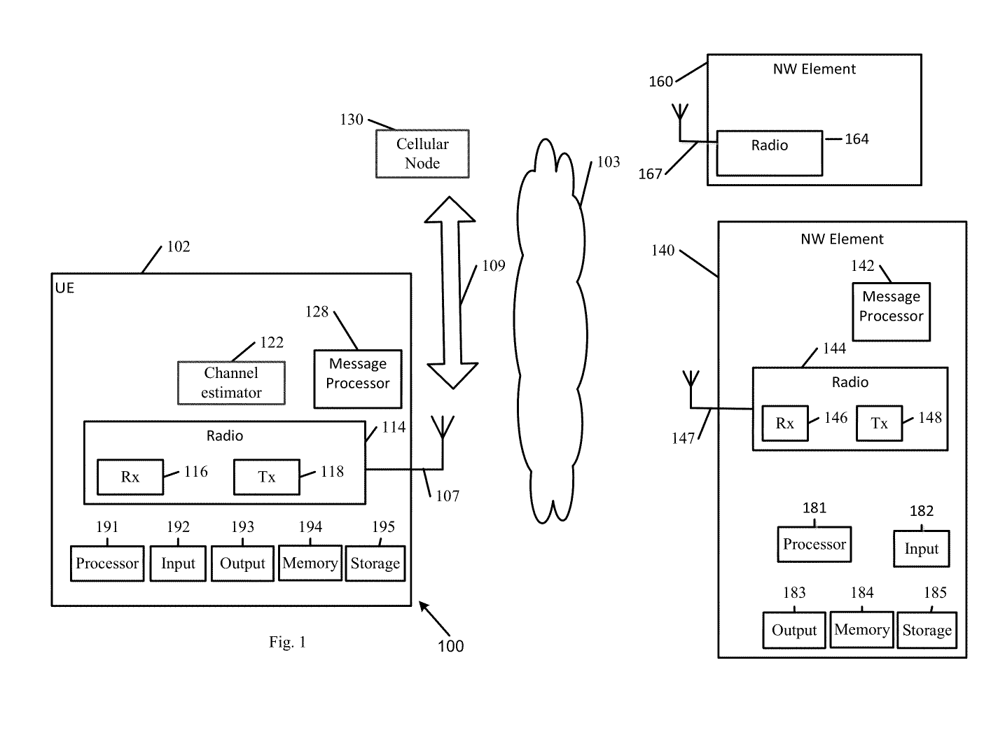

Reference is now made to FIG. 1, which schematically illustrates a block diagram of a wireless communication system 100, in accordance with some demonstrative embodiments.

In some demonstrative embodiments, system 100 may include a cellular network 103.

In some demonstrative embodiments, cellular network 103 may include, for example, a Global System for Mobile (GSM) network, a Universal Mobile Telecommunications System (UMTS) network, a Long Term Evolution (LTE) network, an LTE-advanced network, a Fifth Generation (5G) network, or any other network.

In some demonstrative embodiments, system 100 may include a cellular node 130 configured to control communications over cellular network 103.

In some demonstrative embodiments, cellular node 130 may include, for example, a cellular base station (BS), a Node B, an LTE node, an LTE evolved node B (eNB), and/or any other suitable cellular node configured to control communication in a cellular network.

In some demonstrative embodiments, the cellular node 130 may be configured to cover and/or serve a plurality of users, for example, mobile devices, e.g., a User Equipment (UE), nodes of one or more other cells, e.g., other small cells, relay nodes, and the like. The deployment of the small cells may provide, for example, high-speed wireless access for communication by many users, e.g., simultaneously.

In some demonstrative embodiments, system 100 may include one or more network (NW) elements of cellular network 103. For example, system 100 may include a NW element 140, and/or a NW element 160.

In some demonstrative embodiments, the one or more NW elements may include a wireless communication device, which may be configured to cover and/or serve a plurality of users, for example, mobile devices, e.g., a User Equipment (UE), for example, in one or more small cells within cellular network 103.

In some demonstrative embodiments, NW elements 140 and/or 160 may include mobile or non-mobile devices.

In some demonstrative embodiments, one or more elements of system 100 may perform the functionality of a HetNet, which may utilize a deployment of a mix of technologies, frequencies, cell sizes and/or network architectures, for example, including cellular, WLAN, and/or the like.

In some demonstrative embodiments, the HetNet architecture may enable utilizing a mixture of wireless communication environments, e.g., a WLAN environment and a cellular environment, for example, to optimally respond to rapid changes in customer demand, reduce power consumption, reduce cost, increase efficiency and/or achieve any other benefit.

In some demonstrative embodiments, system 100 may include a UE 102 configured to communicate with the one or more elements of cellular network 103.

In some demonstrative embodiments, UE 102 may include a mobile device.

In some demonstrative embodiments, UE 102, may include, for example, a mobile computer, a laptop computer, an Internet of Things (IoT) device, a notebook computer, a tablet computer, an Ultrabook™ computer, a mobile internet device, a handheld computer, a handheld device, a PDA device, a handheld PDA device, a hybrid device (e.g., combining cellular phone functionalities with PDA device functionalities), a consumer device, a mobile or portable device, a mobile phone, a cellular telephone, a PDA device which incorporates a wireless communication device, a mobile or portable GPS device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a video source, a Personal Media Player (PMP), a digital video camera (DVC), a gaming device, a Digital Still camera (DSC), a media player, a Smartphone, or the like.

In some demonstrative embodiments, UE 102 may include, for example, one or more of a processor 191, an input unit 192, an output unit 193, a memory unit 194, and a storage unit 195; and/or NW element 140 may include, for example, one or more of a processor 181, an input unit 182, an output unit 183, a memory unit 184, and a storage unit 185. UE 102 and/or NW element 140 may optionally include other suitable hardware components and/or software components. In some demonstrative embodiments, some or all of the components of one or more of devices 102 and/or 140 may be enclosed in a common housing or packaging, and may be interconnected or operably associated using one or more wired or wireless links. In other embodiments, components of one or more of UE 102 and/or NW element 140 may be distributed among multiple or separate devices.

Processor 191 and/or processor 181 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 executes instructions, for example, of an Operating System (OS) of UE 102 and/or of one or more suitable applications. Processor 181 executes instructions, for example, of an Operating System (OS) of NW element 140 and/or of one or more suitable applications.

Input unit 192 and/or input unit 182 includes, for example, a keyboard, a keypad, a mouse, a touch-screen, a touch-pad, a track-ball, a stylus, a microphone, or other suitable pointing device or input device. Output unit 193 and/or output unit 183 includes, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

Memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 includes, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by UE 102. Memory unit 184 and/or storage unit 185, for example, may store data processed by NW element 140.

In some demonstrative embodiments, UE 102 may be configured to communicate with the one or more network (NW) elements of cellular network 103.

In some demonstrative embodiments, UE 102, cellular node 130, NW element 140, and/or NW element 160 may include one or more radios to perform wireless communication between UE 102, cellular node 130, NW element 140, and/or NW element 160 and/or one or more other NW elements of cellular network 103. For example, UE 102 may include at least one radio 114, NW element 140 may include at least one radio 144, and/or device 160 may include at least one radio 164.

In some demonstrative embodiments, radios 114, 144 and/or 164 may include one or more wireless receivers (Rx) including circuitry and/or logic to receive wireless communication signals, RF signals, frames, blocks, transmission streams, packets, messages, data items, and/or data. For example, radio 114 may include a receiver 116, and/or radio 144 may include a receiver 146.

In some demonstrative embodiments, radios 114, 144 and/or 164 may include one or more wireless transmitters (Tx) including circuitry and/or logic to send wireless communication signals, RF signals, frames, blocks, transmission streams, packets, messages, data items, and/or data. For example, radio 114 may include a transmitter 118, and/or radio 144 may include a transmitter 148.

In some demonstrative embodiments, radios 114, 144 and/or 164 may include modulation elements, demodulation elements, amplifiers, analog to digital and digital to analog converters, filters, and/or the like. For example, radios 114, 144 and/or 164 may include or may be implemented as part of a wireless Network Interface Card (NIC), and the like.

In some demonstrative embodiments, radios 114, 144 and/or 164 may include, or may be associated with, one or more antennas 107, 147 and/or 167, respectively.

In one example, UE 102 may include a single antenna 107. In other example, UE 102 may include two or more antennas 107.

In one example, NW element 140 may include a single antenna 147. In other example, NW element 140 may include two or more antennas 147.

In one example, device 160 may include a single antenna 167. In other example, device 160 may include two or more antennas 167.

Antennas 107, 147, and/or 167 may include any type of antennas suitable for transmitting and/or receiving wireless communication signals, blocks, frames, transmission streams, packets, messages and/or data. For example, antennas 107, 147, and/or 167 may include any suitable configuration, structure and/or arrangement of one or more antenna elements, components, units, assemblies and/or arrays. Antennas 107, 147, and/or 167 may include, for example, antennas suitable for directional communication, e.g., using beamforming techniques. For example, antennas 107, 147, and/or 167 may include a phased array antenna, a multiple element antenna, a set of switched beam antennas, and/or the like. In some embodiments, antennas 107, 147, and/or 167 may implement transmit and receive functionalities using separate transmit and receive antenna elements. In some embodiments, antennas 107, 147, and/or 167 may implement transmit and receive functionalities using common and/or integrated transmit/receive elements.

In some demonstrative embodiments, UE 102 may include a message processor 128 configured to generate, process and/or access one or messages communicated by UE 102.

In one example, message processor 128 may be configured to generate one or more messages to be transmitted by UE 102, and/or message processor 128 may be configured to access and/or to process one or more messages received by UE 102, e.g., as described below.

In some demonstrative embodiments, NW element 140 may include a message processor 142 configured to generate, process and/or access one or messages communicated by NW element 140.

In one example, message processor 142 may be configured to generate one or more messages to be transmitted by NW element 140, and/or message processor 142 may be configured to access and/or to process one or more messages received by NW element 140, e.g., as described below.

In some demonstrative embodiments, message processors 128 and/or 142 may include circuitry and/or logic, e.g., one or more processors including circuitry, memory circuitry, Media-Access Control (MAC) circuitry, Physical Layer (PHY) circuitry, and/or any other circuitry, configured to perform the functionality of message processors 128 and/or 142. Additionally or alternatively, one or more functionalities of the proximity estimators message processors 128 and/or 142 may be implemented by logic, which may be executed by a machine and/or one or more processors, e.g., as described below.

In some demonstrative embodiments, at least part of the functionality of message processor 128 may be implemented as part of radio 114, and/or at least part of the functionality of message processor 142 may be implemented as part of radio 144.

In other embodiments, the functionality of message processor 128 may be implemented as part of any other element of UE 102, and/or the functionality of message processor 142 may be implemented as part of any other element of device

In some demonstrative embodiments, radios 114, 144, and/or 164 may be configured to communicate over cellular network 103 and over a non-cellular band.

In some demonstrative embodiments, radios 114, 144, and/or 164 may be configured to communicate over a mmWave band.

In one example, radios 114, 144, and/or 164 may be configured to communicate over the 60 GhZ band.

In some demonstrative embodiments, UE 102 may communicate with cellular node 130 over a channel 109 between UE 102 and cellular node 130.

In some demonstrative embodiments, channel 109 may include a MIMO channel.

In some demonstrative embodiments, UE 102 may predict a channel condition of channel 109.

In one example, UE 102 may predict the channel condition of channel 109, for example, to maintain quality and/or performance of communication over channel 109.

In some demonstrative embodiments, UE 102 may include a channel estimator 122 to predict the channel condition of channel 109.

In some demonstrative embodiments channel estimator 122 may include circuitry and/or logic, e.g., one or more processors including circuitry, memory circuitry, Media-Access Control (MAC) circuitry, Physical Layer (PHY) circuitry, and/or any other circuitry, configured to perform the functionality of channel estimator 122. Additionally or alternatively, one or more functionalities of channel estimator 122 may be implemented by logic, which may be executed by a machine and/or one or more processors, e.g., as described below.

In some demonstrative embodiments, channel estimator 122 may perform at least part of the functionality of message processor 128.

In some demonstrative embodiments, UE 102 may trace a ray between UE 102 and cellular node 130 according to a ray tracing algorithm, and may predict the channel condition of channel 109 based on the ray.

In some demonstrative embodiments, UE 102 may trace the ray between UE 102 and cellular node 130, for example, based on a map describing a topology of a location of UE 102.

In one example, the topology may describe a surrounding propagation environment of wireless signals, e.g., a topology of a surrounding area around the location of UE 102.

In some demonstrative embodiments, UE 102 may inaccurately and/or erroneously predict the channel condition of channel 109, for example, if the ray tracing algorithm is based on a non-recent map, a non-updated map, and/or a wrong map.

In one example, UE 102 may inaccurately and/or erroneously predict the channel condition of channel 109, for example, if the map is not updated.

For example, the topology at the area of UE 102 may change, for example, as a result of construction work at the location of UE 102, new buildings, new blocks, new obstacles, new constructions, and/or changes in one or more elements in the surrounding of the location of UE 102, which may occur, for example, after a last update of the map.

In some demonstrative embodiments, using the non-recent map may reduce the accuracy of the predicted channel condition, which, in turn, may reduce performance of the communication between UE 102 and cellular node 130.

Some demonstrative embodiments may enable UE 102 to receive an up to date and/or recent map of the location of UE 102, e.g., as described below.

In some demonstrative embodiments, it may be inefficient and/or inaccurate to maintain the quality and/or the performance of communication over channel 109 using channel state information (CSI) of channel 109, for example, if channel 109 is a MIMO channel.

In one example, the CSI may not be determined accurately, for example, due to implantation impairments.

In some demonstrative embodiments, it may be inefficient and/or inaccurate to maintain the quality and/or the performance of communication over channel 109, for example, using techniques, e.g., partial joint pre-coding, channel estimation and effective feedback schemes, channel prediction schemes, and/or a parameterized feed back compression, when using outdated map information.

In some demonstrative embodiments, at least one NW element of system 100 may store topology information corresponding to at least one region within a coverage area of cellular network 103.

In some demonstrative embodiments, NW element 140 may store topology information corresponding to at least one region within the coverage area of cellular network 103. For example, NW element 140 may store the topology information in memory 184.

In some demonstrative embodiments, UE 102 and NW element 140 may communicate the topology information over the mmWave band.

In one example, UE 102 and NW element 140 may communicate the topology information over the mmWave band, which may, for example, enable communication of a bulk data with low latency and high bandwidth, e.g., compared to cellular network.

In some demonstrative embodiments, radio 144 may send the topology information to UE 102, e.g., over the mmWave band, for example, based on the location of UE 102.

In one example, radio 144 may send the topology information to UE 102, for example, when UE 102 enters and/or is within the coverage area of NW element 140.

In some demonstrative embodiments, the topology information may correspond to a topology at the location of UE 102. For example, the topology information may describe the surrounding propagation environment of UE 102.

In some demonstrative embodiments, radio 144 may periodically transmit the topology information to UE 102.

In other embodiments, radio 144 may transmit the topology information to UE 102 based on one or more events and/or criteria.

In one example, radio 144 may transmit the topology information to UE 102, for example, when the topology information is updated at NW element 140.

In some demonstrative embodiments, radio 144 may transmit the topology information to UE 102 based on a request from UE 102, e.g., as described below.

In some demonstrative embodiments, radio 114 may receive the topology information from NW element 140.

In one example, message processor 142 may generate a message to transmit the topology information to UE 102, and/or message processor 128 may process the topology information received from NW element 140.

In some demonstrative embodiments, UE 102 may store the topology information, e.g., in memory 194.

In some demonstrative embodiments, radio 114 may periodically receive the topology information from NW element 140.

In some demonstrative embodiments, channel estimator 122 may predict the channel condition of channel 109, for example, based on the topology information.

In some demonstrative embodiments, channel estimator 122 may trace the ray between cellular node 130 and UE 102 according to the ray tracing algorithm using the topology information.

In some demonstrative embodiments, channel estimator 122 may predict the channel condition of channel 109 based on the ray.

In one example, channel estimator 122 may predict the channel condition using Wiener or Kalman filtering or any other algorithm.

In some demonstrative embodiments, channel estimator 122 may determine predicted Channel State Information (CSI) of channel 109, for example, based on the topology information.

In some demonstrative embodiments, radio 114 may determine one or more radio settings of radio 114, for example, based on the predicted channel condition.

In some demonstrative embodiments, the radio settings may include a transmit setting to transmit to cellular node 130, and/or a receive setting to receive from cellular node 130.

In some demonstrative embodiments, UE 102 and NW element 140 may communicate the topology information based on version information of the topology information, e.g., as described below.

In some demonstrative embodiments, radio 114 may transmit version information to NW element 140 over cellular network 103.

In some demonstrative embodiments, the version information may correspond to a version of stored topology information stored by UE 102, e.g., in memory 195.

In some demonstrative embodiments, NW element 144 may receive the version information of the stored topology information in UE 102.

In some demonstrative embodiments, NW element 144 may compare the version of the stored topology information in UE 102 and a version of the topology information in memory 184.

In some demonstrative embodiments, NW element 144 may send the topology information to UE 102, for example, if the version of the topology stored in memory 184 is newer than the version of the stored topology information in UE 102.

In one example, the version may include a time stamp, e.g., a time and/or date of the last update to the version. According to this example, NW element 144 may send the topology information to UE 102, for example, if the date of the topology information is after the date of the stored topology information in UE 102.

In another example, NW element 144 may send the topology information to UE 102, for example, based on a card identification (ID) of UE 102, e.g., a number, a string, a combination of digits and letters and/or the like. For example, the topology information may be associated with one or more card IDs, e.g., to indicate the topology information at NW element 140 may be relevant for UEs having the one or more card IDs. According to this example, NW element 144 may send the topology information to UE 102, for example, if the card ID of UE 102 is identical to a card ID of the topology information at NW element 140, and a time stamp of the version of the topology information at UE 102 is older than a time stamp of the topology information at NW element 140.

In another example, the version may include a version number. According to this example, NW element 144 may send the topology information to UE 102, for example, if the version number of the topology information is greater than the version number of the stored topology information in UE 102.

In another example, the version may include any other representation configured to differentiate between different versions of the topology information.

In some demonstrative embodiments, UE 102 may receive the topology information from NW element 144, for example, if the version of the topology stored in memory 184 is newer than the version of the stored topology information in UE 102.

In some demonstrative embodiments, UE 102 may update the one or more radio settings of radio 144, based on the received topology information from NW element 140, e.g., as described above.

In some demonstrative embodiments, the topology information may be stored by one or more other elements of cellular network 103, e.g., in addition or instead of NW element 144.

In some demonstrative embodiments, the topology information may be stored in cellular node 130.

In some demonstrative embodiments, cellular node 130 may send the topology information to UE 102, for example, once UE 102 enters the coverage area of cellular network 103.

In some demonstrative embodiments, radio 114 may receive the topology information from cellular node 130.

In some demonstrative embodiments, channel estimator 122 may estimate the channel condition of channel 109, e.g., based on the received topology information from cellular node 130.

In some demonstrative embodiments, the topology information may be stored in another NW element of cellular network 103.

In some demonstrative embodiments, the topology information may be stored in NW element 160.

In some demonstrative embodiments, NW element 160 may send the topology information to UE 102 via NW element 140, for example, once UE 102 enters the coverage area of NW element 140.

In some demonstrative embodiments, NW element 140 may perform the functionality of a relay NW element configured to relay the topology information between NW element 160 and UE 102.

In some demonstrative embodiments, NW element 160 may send the topology information to NW element 140.

In some demonstrative embodiments, radio 144 may receive the topology information from NW element 160 and may forward the topology information to UE 102.

In some demonstrative embodiments, radio 114 may receive the topology information from NW element 160 via NW element 140.

In some demonstrative embodiments, channel estimator 122 may estimate the channel condition of channel 109, e.g., based on the received topology information from NW element 160 via NW element 140.

In some demonstrative embodiments, receiving the topology information, e.g., from NW element 140, NW element 160, and/or cellular node 130, may enable UE 102 to accurately predict the channel condition of channel 109, which may improve communication between UE 102 and cellular node 130 over channel 109.

In some demonstrative embodiments, receiving the topology information at UE 102 may enable channel estimator 122 to predict the channel condition of channel 109, e.g., based on a most recent topology map. The most recent topology map may provide channel estimator 122 with knowledge of a recent, e.g., the most recent, surrounding propagation environment of the location of UE 102, which may enable channel estimator 122 to more accurately predict the channel condition of channel 109.

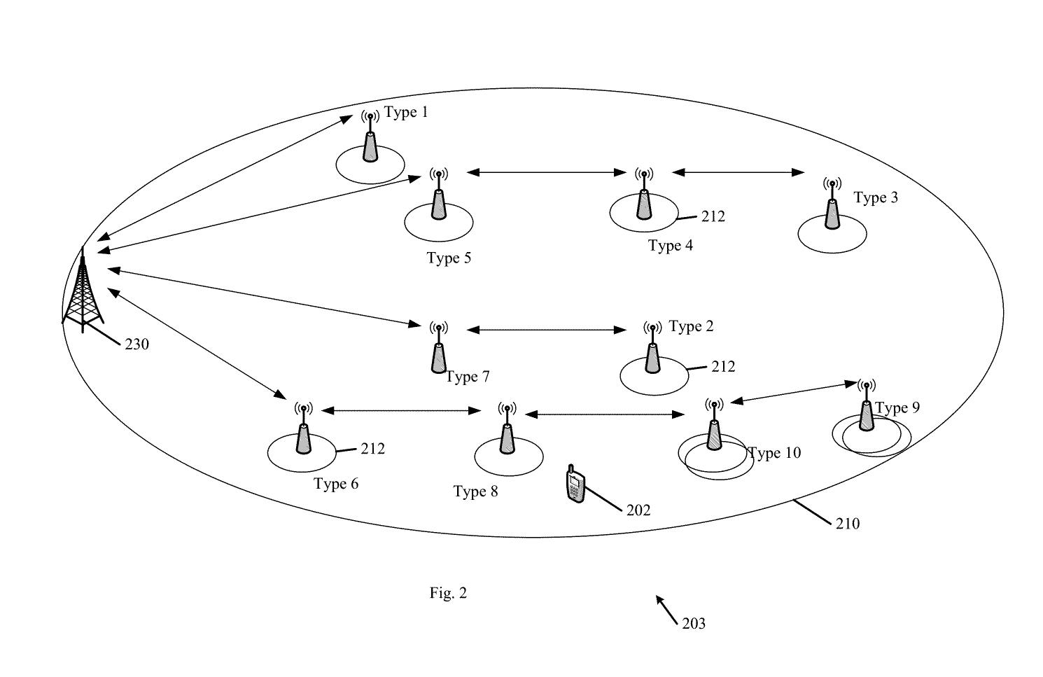

Reference is made to FIG. 2, which schematically illustrates a cellular network 203 controlled by a cellular node 230, e.g., a Base Station (BS), in accordance with some demonstrative embodiments. For example, cellular network 203 may perform the functionality of cellular network 103 (FIG. 1), and/or cellular node 230 may perform the functionality of cellular node 130 (FIG. 1).

In some demonstrative embodiments, cellular network 203 may include a UE 202 to communicate with cellular node 230 via a channel between UE 202 and cellular node 230. For example, UE 202 may perform the functionality of UE 102 (FIG. 1).

In some demonstrative embodiments, cellular network 203 may perform the functionality of a heterogeneous network. The heterogeneous network may include an overlay macro cell 210 including small cells 212.

In some demonstrative embodiments, small cells 212 may be configured to offload traffic from macro cell 210.

In some demonstrative embodiments, the small cells 212 may be controlled by a plurality of NW elements denoted, Type 1-Type 10.

In some demonstrative embodiments, one or more NW elements, e.g., NW element Type 1, may be connected directly to cellular node 230.

In some demonstrative embodiments, one or more NW elements, e.g., a NW element Type 4, may be connected to cellular node 230 via one or more other NW elements.

In some demonstrative embodiments, a NW element of the plurality of NW elements may support one or more capabilities, e.g., as described below.

In some demonstrative embodiments, the plurality of NW elements may support communication over cellular network 203, e.g., via mobile broadband (MBB), for example, LTE, and/or via non-cellular band, e.g., the mmWave band.

In some demonstrative embodiments, the plurality of NW elements may have or may not have relay capabilities, for example, to transmit and/or relay topology information to UE 202.

In some demonstrative embodiments, the plurality of NW elements may have or may not have backhaul (BH) capability via the mmWave band.

In some demonstrative embodiments, the one or more NW elements Type 1-Type 10 may have, for example, one or more of the following capabilities:

TABLE 1

| | | | Relay |
|---|---|---|---|
| NW element | BH | Access link | Function |
| Type 1 | mmWave | LTE *) | No |
| Type 2 | mmWave | mmWave | No |
| Type 3 | mmWave | mmWave + | No |
| | | LTE*) | |
| Type 4 | mmWave | LTE *) | Yes |
| Type 5 | mmWave | mmWave | Yes |
| Type 6 | mmWave | mmWave + | Yes |
| | | LTE*) | |
| Type 7 | mmWave | None | Yes |
| Type 8 | mmWave | None/only for | Yes |
| | | map updates | |
| Type 9 | mmWave | LTE/mmWave | No |
| | | for map | |
| | | updates only | |
| Type 10 | mmWave | LTE/mmWave | Yes |
| | | for map | |
| | | updates only | |

As shown in Table 1, NW element Type 1 does not support the communication over the mmWave band, and the relay capability. Accordingly, NW element Type 1 may not be able to send and/or to relay the topology information to UE 202.

As shown in Table 1, NW element Type 3 supports the communication over the mmWave band and does not support the relay capability. Accordingly, NW element Type 3 may be able to send the topology information to UE 202 and may not be able to relay the topology information to UE 202.

As shown in Table 1, NW element Type 6 supports the communication over the mmWave band and the relay capability. Accordingly, NW element Type 3 may be able to send and/or to relay the topology information to UE 202.

As shown in Table 1, NW element Types 8 and 10 support the communication over the mmWave band only for sending the topology information, and the relay capability. Accordingly, NW element Types 8 and/or 10 may be able to send and/or to relay the topology information to UE 202.

As shown in Table 1, NW element Type 9 supports the communication over the mmWave band only for sending the topology information, and does not support the relay capability. Accordingly, NW element Type 9 may be able to send the topology information to UE 202, and may not be able to relay the topology information to UE 202.

In other embodiments, the NW elements of FIG. 2 may have any other additional and/or alternative capabilities.

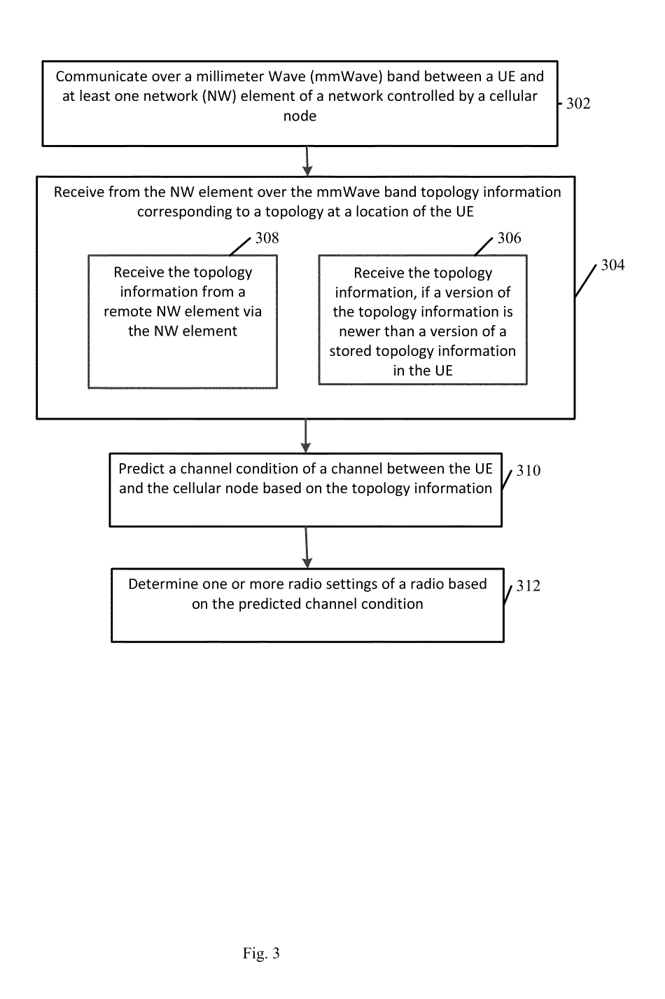

Reference is made to FIG. 3, which schematically illustrates a method of predicting a channel condition, in accordance with some demonstrative embodiments. For example, one or more of the operations of the method of FIG. 3 may be performed by a wireless communication system, e.g., system 100 (FIG. 1); a UE, e.g., UE 102 (FIG. 1); a NW element, e.g., NW element 140 (FIG. 1); a cellular node, e.g., cellular node 130 (FIG. 1); a radio, e.g., radios 114 and/or 144 (FIG. 1); a message processor, e.g., messages processors 128 and/or 158 (FIG. 1); a receiver, e.g., receivers 116 and/or 146 (FIG. 1); a transmitter, e.g., transmitter 118 and/or 148 (FIG. 1); and/or a channel estimator, e.g., channel estimator 122 (FIG. 1).

As indicated at block 302, the method may include communicating over a mmWave band with at least one NW element of a network controlled by a cellular node. For example, UE 102 (FIG. 1) may communicate over the mmWave band with NW element 140 (FIG. 1) of Network 103 (FIG. 1) controlled by cellular node 130 (FIG. 1), e.g., as described above.

As indicated at block 304, the method may include receiving from the NW element topology information corresponding to a topology at a location of the UE. For example, UE 102 (FIG. 1) may receive from NW element 140 (FIG. 1) the topology information, which corresponds to the topology at the location of UE 102 (FIG. 1), e.g., as described above.

As indicated at block 306, receiving the topology information may include receiving the topology information, if a version of the topology information is newer than a version of a stored topology information in the UE. For example, UE 102 (FIG. 1) may receive the topology information, if the version of the topology information is newer than a version of the stored topology information in UE 102 (FIG. 1), e.g., as described above.

As indicated at block 308, receiving the topology information may include receiving the topology information from a remote NW element via the NW element. For example, UE 102 (FIG. 1) may receive the topology information from NW element 160 (FIG. 1) via NW element 140 (FIG. 1), e.g., as described above.

As indicated at block 310, the method may include predicting a channel condition of a channel between the UE and the cellular node based on the topology information. For example, channel estimator 122 (FIG. 1) may predict the channel condition of channel 109 (FIG. 1) based on the topology information, e.g., as described above.

As indicated at block 312, the method may include determining one or more radio settings of a radio of the UE based on the predicted channel condition. For example, radio 114 may determine the transmit settings and/or the receive settings of radio 114 (FIG. 1) to communicate with cellular node 130 (FIG. 1), based on the predicted channel condition, e.g., as described above.

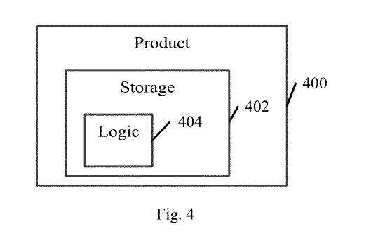

Reference is made to FIG. 4, which schematically illustrates a product of manufacture 400, in accordance with some demonstrative embodiments. Product 400 may include a non-transitory machine-readable storage medium 402 to store logic 404, which may be used, for example, to perform at least part of the functionality of UE 102 (FIG. 1), cellular node 130 (FIG. 1), NW elements 140 and/or 160 (FIG. 1), radios 114, 144 and/or 164 (FIG. 1), channel estimator 122 (FIG. 1), message processors 128 and/or 158 (FIG. 1) and/or to perform one or more operations of the method of FIG. 3. The phrase “non-transitory machine-readable medium” is directed to include all computer-readable media, with the sole exception being a transitory propagating signal.

In some demonstrative embodiments, product 400 and/or machine-readable storage medium 402 may include one or more types of computer-readable storage media capable of storing data, including volatile memory, non-volatile memory, removable or non-removable memory, erasable or non-erasable memory, writeable or re-writeable memory, and the like. For example, machine-readable storage medium 1002 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 404 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 404 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### Examples

The following examples pertain to further embodiments.

Example 1 includes a User Equipment (UE) comprising a radio to communicate over a millimeter Wave (mmWave) band with at least one network (NW) element of a network controlled by a cellular node, and to receive from the NW element topology information corresponding to a topology at a location of the UE; and a channel estimator to predict a channel condition of a channel between the UE and the cellular node based on the topology information.

Example 2 includes the subject mater of Example 1, and optionally, wherein the radio is to determine one or more radio settings of the radio based on the predicted channel condition, the radio settings including at least one radio setting selected from the group consisting of a transmit setting to transmit to the cellular node, and a receive setting to receive from the cellular node.

Example 3 includes the subject mater of Example 1 or 2, and optionally, wherein the channel estimator to trace a ray between the cellular node and the UE according to a ray tracing algorithm using the topology information, and to predict the channel condition based on the ray.

Example 4 includes the subject mater of any one of Examples 1-3, and optionally, wherein the channel estimator is to determine predicted Channel State Information (CSI) of the channel based on the topology information.

Example 5 includes the subject mater of any one of Examples 1-4, and optionally, wherein the radio is to transmit version information to the NW element over the network, the version information corresponding to a version of stored topology information stored by the UE, and to receive the topology information, if a version of the topology information is newer than the version of the stored topology information.

Example 6 includes the subject mater of any one of Examples 1-5, and optionally, wherein the radio is to periodically receive the topology information from the NW element.

Example 7 includes the subject mater of any one of Examples 1-6, and optionally, wherein the radio is to receive the topology information from a remote NW element via the NW element.

Example 8 includes the subject mater of any one of Examples 1-7, and optionally, wherein the radio is to receive the topology information from the cellular node.

Example 9 includes the subject mater of any one of Examples 1-8, and optionally, wherein the channel is a Multiple In Multiple Out (MIMO) channel.

Example 10 includes the subject mater of any one of Examples 1-9, and optionally, comprising one or more antennas; a memory; and a processor.

Example 11 includes a wireless communication device comprising a memory to store topology information corresponding to at least one region within a coverage area of a cellular network controlled by a cellular node; and a radio to communicate with a User Equipment (UE) over a non-cellular band, and, based on a location of the UE, to send the topology information to the UE.

Example 12 includes the subject mater of Example 11, and optionally, wherein the radio is to receive version information from the UE over the cellular network, the version information corresponding to a version of stored topology information stored by the UE, and to send the topology information, if a version of the topology information is newer than the version of the stored topology information.

Example 13 includes the subject mater of Example 11 or 12, and optionally, wherein the radio is to periodically transmit the topology information.

Example 14 includes the subject mater of any one of Examples 11-13, and optionally, wherein the radio is to receive the topology information from a remote network (NW) element of the cellular network, and to forward the topology information to the UE.

Example 15 includes the subject mater of any one of Examples 11-14, and optionally, wherein the non-cellular band is a millimeter wave (mmWave) band.

Example 16 includes the subject mater of any one of Examples 11-15, and optionally, comprising one or more antennas; and a processor.

Example 17 includes a system including a User Equipment (UE), the UE comprising one or more antennas; a memory; a processor; a radio to communicate over a millimeter Wave (mmWave) band with at least one network (NW) element of a network controlled by cellular node, and to receive from the NW element topology information corresponding to a topology at a location of the UE; and a channel estimator to predict a channel condition of a channel between the UE and the cellular node based on the topology information.

Example 18 includes the subject mater of Example 17, and optionally, wherein the radio is to determine one or more radio settings of the radio based on the predicted channel condition, the radio settings including at least one radio setting selected from the group consisting of a transmit setting to transmit to the cellular node, and a receive setting to receive from the cellular node.

Example 19 includes the subject mater of Example 17 or 18, and optionally, wherein the channel estimator to trace a ray between the cellular node and the UE according to a ray tracing algorithm using the topology information, and to predict the channel condition based on the ray.

Example 20 includes the subject mater of any one of Examples 17-19, and optionally, wherein the channel estimator is to determine predicted Channel State Information (CSI) of the channel based on the topology information.

Example 21 includes the subject mater of any one of Examples 17-20, and optionally, wherein the radio is to transmit version information to the NW element over the network, the version information corresponding to a version of stored topology information stored by the UE, and to receive the topology information, if a version of the topology information is newer than the version of the stored topology information.

Example 22 includes the subject mater of any one of Examples 17-21, and optionally, wherein the radio is to periodically receive the topology information from the NW element.

Example 23 includes the subject mater of any one of Examples 17-22, and optionally, wherein the radio is to receive the topology information from a remote NW element via the NW element.

Example 24 includes the subject mater of any one of Examples 17-23, and optionally, wherein the radio is to receive the topology information from the cellular node.

Example 25 includes the subject mater of any one of Examples 17-24, and optionally, wherein the channel is a Multiple In Multiple Out (MIMO) channel.

Example 26 includes a system including a wireless communication device, the wireless communication device comprising one or more antennas; a processor; a memory to store topology information corresponding to at least one region within a coverage area of a cellular network controlled by a cellular node; and a radio to communicate with a User Equipment (UE) over a non-cellular band, and, based on a location of the UE, to send the topology information to the UE.

Example 27 includes the subject mater of Example 26, and optionally, wherein the radio is to receive version information from the UE over the cellular network, the version information corresponding to a version of stored topology information stored by the UE, and to send the topology information, if a version of the topology information is newer than the version of the stored topology information.

Example 28 includes the subject mater of Example 26 or 27, and optionally, wherein the radio is to periodically transmit the topology information.

Example 29 includes the subject mater of any one of Examples 26-28, and optionally, wherein the radio is to receive the topology information from a remote network (NW) element of the cellular network, and to forward the topology information to the UE.

Example 30 includes the subject mater of any one of Examples 26-29, and optionally, wherein the non-cellular band is a millimeter wave (mmWave) band.

Example 31 includes a method to be performed at a User Equipment (UE), the method comprising communicating over a millimeter Wave (mmWave) band with at least one network (NW) element of a network controlled by a cellular node; receiving from the NW element over the mmWave band topology information corresponding to a topology at a location of the UE; and predicting a channel condition of a channel between the UE and the cellular node based on the topology information.

Example 32 includes the subject mater of Example 31, and optionally, comprising determining one or more radio settings of a radio of the UE based on the predicted channel condition, the radio settings including at least one radio setting selected from the group consisting of a transmit setting to transmit to the cellular node, and a receive setting to receive from the cellular node.

Example 33 includes the subject mater of Example 31 or 32, and optionally, comprising tracing a ray between the cellular node and the UE according to a ray tracing algorithm using the topology information, and predicting the channel condition based on the ray.

Example 34 includes the subject mater of any one of Examples 31-33, and optionally, comprising determining predicted Channel State Information (CSI) of the channel based on the topology information.

Example 35 includes the subject mater of any one of Examples 31-34, and optionally, comprising transmitting version information to the NW element over the network, the version information corresponding to a version of stored topology information stored by the UE, and receiving the topology information, if a version of the topology information is newer than the version of the stored topology information.

Example 36 includes the subject mater of any one of Examples 31-35, and optionally, comprising periodically receiving the topology information from the NW element.

Example 37 includes the subject mater of any one of Examples 31-36, and optionally, comprising receiving the topology information from a remote NW element via the NW element.

Example 38 includes the subject mater of any one of Examples 31-37, and optionally, comprising receiving the topology information from the cellular node.

Example 39 includes the subject mater of any one of Examples 31-38, and optionally, wherein the channel is a Multiple In Multiple Out (MIMO) channel.

Example 40 includes a method to be performed at a wireless communication device, the method comprising storing topology information corresponding to at least one region within a coverage area of a cellular network controlled by a cellular node; communicating with a User Equipment (UE) over a non-cellular band; and based on a location of the UE, sending the topology information to the UE over the non-cellular band.

Example 41 includes the subject mater of Example 40, and optionally, comprising receiving version information from the UE over the cellular network, the version information corresponding to a version of stored topology information stored by the UE, and sending the topology information, if a version of the topology information is newer than the version of the stored topology information.

Example 42 includes the subject mater of Example 40 or 41, and optionally, comprising periodically transmitting the topology information.

Example 43 includes the subject mater of any one of Examples 40-42, and optionally, comprising receiving the topology information from a remote network (NW) element of the cellular network, and forwarding the topology information to the UE.

Example 44 includes the subject mater of any one of Examples 40-43, and optionally, wherein the non-cellular band is a millimeter wave (mmWave) band.

Example 45 includes a product including one or more tangible computer-readable non-transitory storage media comprising computer-executable instructions operable to, when executed by at least one computer processor, enable the at least one computer processor to implement a method at a User Equipment (UE), the method comprising communicating over a millimeter Wave (mmWave) band with at least one network (NW) element of a network controlled by a cellular node; receiving from the NW element topology information corresponding to a topology at a location of the UE; and predicting a channel condition of a channel between the UE and the cellular node based on the topology information.

Example 46 includes the subject mater of Example 45, and optionally, wherein the method comprises determining one or more radio settings of a radio of the UE based on the predicted channel condition, the radio settings including at least one radio setting selected from the group consisting of a transmit setting to transmit to the cellular node, and a receive setting to receive from the cellular node.

Example 47 includes the subject mater of Example 45 or 46, and optionally, wherein the method comprises tracing a ray between the cellular node and the UE according to a ray tracing algorithm using the topology information, and predicting the channel condition based on the ray.

Example 48 includes the subject mater of any one of Examples 45-47, and optionally, wherein the method comprises determining predicted Channel State Information (CSI) of the channel based on the topology information.

Example 49 includes the subject mater of any one of Examples 45-48, and optionally, wherein the method comprises transmitting version information to the NW element over the network, the version information corresponding to a version of stored topology information stored by the UE, and receiving the topology information, if a version of the topology information is newer than the version of the stored topology information.

Example 50 includes the subject mater of any one of Examples 45-49, and optionally, wherein the method comprises periodically receiving the topology information from the NW element.

Example 51 includes the subject mater of any one of Examples 45-50, and optionally, wherein the method comprises receiving the topology information from a remote NW element via the NW element.

Example 52 includes the subject mater of any one of Examples 45-51, and optionally, wherein the method comprises receiving the topology information from the cellular node.

Example 53 includes the subject mater of any one of Examples 45-52, and optionally, wherein the channel is a Multiple In Multiple Out (MIMO) channel.

Example 54 includes a product including one or more tangible computer-readable non-transitory storage media comprising computer-executable instructions operable to, when executed by at least one computer processor, enable the at least one computer processor to implement a method at a wireless communication device, the method comprising storing topology information corresponding to at least one region within a coverage area of a cellular network controlled by a cellular node; communicating with a User Equipment (UE) over a non-cellular band; and sending the topology information to the UE based on a location of the UE.

Example 55 includes the subject mater of Example 54, and optionally, wherein the method comprises receiving version information from the UE over the cellular network, the version information corresponding to a version of stored topology information stored by the UE, and sending the topology information, if a version of the topology information is newer than the version of the stored topology information.

Example 56 includes the subject mater of Example 54 or 55, and optionally, wherein the method comprises periodically transmitting the topology information.

Example 57 includes the subject mater of any one of Examples 54-56, and optionally, wherein the method comprises receiving the topology information from a remote network (NW) element of the cellular network, and forwarding the topology information to the UE.

Example 58 includes the subject mater of any one of Examples 54-57, and optionally, wherein the non-cellular band is a millimeter wave (mmWave) band.

Example 59 includes an apparatus of wireless communication, the apparatus comprising means for communicating over a millimeter Wave (mmWave) band between a User Equipment (UE) and at least one network (NW) element of a network controlled by a cellular node; means for receiving from the NW element topology information corresponding to a topology at a location of the UE; and means for predicting a channel condition of a channel between the UE and the cellular node based on the topology information.

Example 60 includes the subject mater of Example 59, and optionally, comprising means for determining one or more radio settings of a radio of the UE based on the predicted channel condition, the radio settings including at least one radio setting selected from the group consisting of a transmit setting to transmit to the cellular node, and a receive setting to receive from the cellular node.

Example 61 includes the subject mater of Example 59 or 60, and optionally, comprising means for tracing a ray between the cellular node and the UE according to a ray tracing algorithm using the topology information, and predicting the channel condition based on the ray.

Example 62 includes the subject mater of any one of Examples 59-61, and optionally, comprising means for determining predicted Channel State Information (CSI) of the channel based on the topology information.

Example 63 includes the subject mater of any one of Examples 59-62, and optionally, comprising means for transmitting version information to the NW element over the network, the version information corresponding to a version of stored topology information stored by the UE, and receiving the topology information, if a version of the topology information is newer than the version of the stored topology information.

Example 64 includes the subject mater of any one of Examples 59-63, and optionally, comprising means for periodically receiving the topology information from the NW element.

Example 65 includes the subject mater of any one of Examples 59-64, and optionally, comprising means for receiving the topology information from a remote NW element via the NW element.

Example 66 includes the subject mater of any one of Examples 59-65, and optionally, comprising means for receiving the topology information from the cellular node.

Example 67 includes the subject mater of any one of Examples 59-66, and optionally, wherein the channel is a Multiple In Multiple Out (MIMO) channel.

Example 68 includes an apparatus of wireless communication, the apparatus comprising means for storing at a wireless communication device topology information corresponding to at least one region within a coverage area of a cellular network controlled by a cellular node; means for communicating with a User Equipment (UE) over a non-cellular band; and means for sending the topology information to the UE, based on a location of the UE.

Example 69 includes the subject mater of Example 68, and optionally, comprising means for receiving version information from the UE over the cellular network, the version information corresponding to a version of stored topology information stored by the UE, and means for sending the topology information, if a version of the topology information is newer than the version of the stored topology information.

Example 70 includes the subject mater of Example 68 or 69, and optionally, comprising means for periodically transmitting the topology information.

Example 71 includes the subject mater of any one of Examples 68-70, and optionally, comprising means for receiving the topology information from a remote network (NW) element of the cellular network, and means for forwarding the topology information to the UE.

Example 72 includes the subject mater of any one of Examples 68-71, and optionally, wherein the non-cellular band is a millimeter wave (mmWave) band.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. A User Equipment (UE) comprising:
a radio to communicate over a millimeter Wave (mmWave) band with at least one network (NW) element of a network controlled by a cellular node, and to receive from said NW element topology information corresponding to a topology at a location of said UE; and
a channel estimator to predict a channel condition of a channel between said UE and said cellular node based on said topology information.

2. The UE of claim 1, wherein said radio is to determine one or more radio settings of said radio based on the predicted channel condition, the radio settings including at least one radio setting selected from the group consisting of a transmit setting to transmit to said cellular node, and a receive setting to receive from said cellular node.

3. The UE of claim 1, wherein said channel estimator to trace a ray between said cellular node and said UE according to a ray tracing algorithm using said topology information, and to predict said channel condition based on said ray.

4. The UE of claim 1, wherein said channel estimator is to determine predicted Channel State Information (CSI) of said channel based on said topology information.

5. The UE of claim 1, wherein said radio is to transmit version information to said NW element over said network, the version information corresponding to a version of stored topology information stored by said UE, and to receive said topology information, if a version of said topology information is newer than the version of said stored topology information.

6. The UE of claim 1, wherein said radio is to periodically receive said topology information from said NW element.

7. The UE of claim 1, wherein said radio is to receive said topology information from a remote NW element via said NW element.

8. The UE of claim 1, wherein said radio is to receive said topology information from said cellular node.

9. The UE of claim 1, wherein said channel is a Multiple In Multiple Out (MIMO) channel.

10. The UE of claim 1 comprising:
one or more antennas;
a memory; and
a processor.

11. A wireless communication device comprising:
a memory to store topology information corresponding to at least one region within a coverage area of a cellular network controlled by a cellular node; and
a radio to communicate with a User Equipment (UE) over a non-cellular band, and, based on a location of said UE, to send said topology information to said UE.

12. The wireless communication device of claim 11, wherein said radio is to receive version information from said UE over said cellular network, the version information corresponding to a version of stored topology information stored by said UE, and to send said topology information, if a version of said topology information is newer than the version of said stored topology information.

13. The wireless communication device of claim 11, wherein said radio is to periodically transmit said topology information.

14. The wireless communication device of claim 11, wherein said radio is to receive said topology information from a remote network (NW) element of said cellular network, and to forward said topology information to said UE.

15. The wireless communication device of claim 11, wherein said non-cellular band is a millimeter wave (mmWave) band.

16. The wireless communication device of claim 11 comprising:
one or more antennas; and
a processor.

17. A product including one or more tangible computer-readable non-transitory storage media comprising computer-executable instructions operable to, when executed by at least one computer processor, enable the at least one computer processor to implement a method at a User Equipment (UE), the method comprising:
communicating over a millimeter Wave (mmWave) band with at least one network (NW) element of a network controlled by a cellular node;
receiving from said NW element topology information corresponding to a topology at a location of said UE; and
predicting a channel condition of a channel between said UE and said cellular node based on said topology information.

18. The product of claim 17, wherein said method comprises determining one or more radio settings of a radio of said UE based on the predicted channel condition, the radio settings including at least one radio setting selected from the group consisting of a transmit setting to transmit to said cellular node, and a receive setting to receive from said cellular node.

19. The product of claim 17, wherein said method comprises tracing a ray between said cellular node and said UE according to a ray tracing algorithm using said topology information, and predicting said channel condition based on said ray.

20. The product of claim 17, wherein said method comprises determining predicted Channel State Information (CSI) of said channel based on said topology information.

21. The product of claim 17, wherein said method comprises transmitting version information to said NW element over said network, the version information corresponding to a version of stored topology information stored by said UE, and receiving said topology information, if a version of said topology information is newer than the version of said stored topology information.

22. A product including one or more tangible computer-readable non-transitory storage media comprising computer-executable instructions operable to, when executed by at least one computer processor, enable the at least one computer processor to implement a method at a wireless communication device, the method comprising:
storing topology information corresponding to at least one region within a coverage area of a cellular network controlled by a cellular node;
communicating with a User Equipment (UE) over a non-cellular band; and
sending said topology information to said UE based on a location of said UE.

23. The product of claim 22, wherein said method comprises receiving version information from said UE over said cellular network, the version information corresponding to a version of stored topology information stored by said UE, and sending said topology information, if a version of said topology information is newer than the version of said stored topology information.

24. The product of claim 22, wherein said method comprises periodically transmitting said topology information.

25. The product of claim 22, wherein said method comprises receiving said topology information from a remote network (NW) element of said cellular network, and forwarding said topology information to said UE.
